(19) United States
(12) Patent Application Publication
(10) Pub. No.: US 2014/0113788 A1
(43) Pub. Date: Apr. 24, 2014

(54) PACKAGING PROCESS

(71) Applicant: Tzu-Wei Huang, Hsinchu County (TW)

(72) Inventor: Tzu-Wei Huang, Hsinchu County (TW)

(21) Appl. No.: 13/707,615

(22) Filed: Dec. 7, 2012

(30) Foreign Application Priority Data
Oct. 18, 2012 (TW) 101138468

(51) Int. Cl. B31B 17/00

(52) U.S. Cl. CPC B31B 17/00
USPC 493/128

(57) ABSTRACT

A packaging process is provided. A package mother board having an upper surface, a lower surface, a device disposing area and a peripheral area surrounding the device disposing area is provided. Multiple semiconductor devices are disposed on the upper surface. The semiconductor devices are located in the device disposing area. A carrier having a center area and an edge area surrounding the center area is provided. An adhesive layer is formed between the peripheral area and the edge area. The center area of the carrier is disposed corresponding to the device disposing area of the package mother board. The edge area of the carrier is disposed corresponding to the peripheral area of the package mother board. The adhesive layer is in a state of semi-curing, and the package mother board is bonded to the carrier via the adhesive layer. A baking process is performed to completely cure the adhesive layer.

### CROSS-REFERENCE TO RELATED APPLICATION

This application claims the priority benefit of Taiwan application serial no. 101138468, filed on Oct. 18, 2012. The entirety of the above-mentioned patent application is hereby incorporated by reference herein and made a part of this specification.

### BACKGROUND

1. Field of the Invention

The invention relates to a packaging process, and more particularly, to a packaging process with a better reliability.

2. Description of Related Art

In recent years, with the rapid progress of the electronic technology, high-tech electronic products have been developed, and thus more user-friendly electronic products with better functions have been continuously introduced and have been designed to cater to the trend of being light, thin, short, and small. In the manufacturing processes of semiconductors, a substrate type carrier is one of the most common structural components and is mainly characterized into two types, including the laminated type and the built-up type. Generally, the substrate of the carrier is mainly formed by a plurality of patterned circuit layers and a plurality of dielectric layers alternately stacked on one another. The surface of the substrate has a plurality of contacts which serve as input/output media for connecting chips or external circuits. Because the substrate type carrier has the advantages of high layout density, compact assembly and good performance, the substrate type carrier has become an essential structural component during the packaging process.

A conventional LGA package structure is mainly composed of a package substrate, a chip, a plurality of solder wires and a molding compound. An upper surface of the package substrate have a plurality of pads, for example, and the chip is disposed on the upper surface of the package substrate and is coupled to the pads via the solder wires. In addition, the molding compound is disposed on the upper surface and covers the chip and the solder wires. Furthermore, a lower surface of the package substrate has a plurality of pads, and a pre-solder is formed on the pads to couple the LAG package structure to the external environment.

Generally, when the package substrate is shipped out from the factory, the pre-solder has already been formed on the pads. The LGA package structure is coupled to an external circuit board through the pre-solder by reflowing the pre-solder alone to form an electrical conduction. A surface treatment process is usually performed to the package substrate to form an electroplated nickel-gold layer on the circuits of the package substrate. However, this surface treatment process also forms an electroplated layer on the pads on the lower surface of the package substrate, thereby influencing the structural reliability and electrical performance of the subsequently formed package structure.

### SUMMARY OF THE INVENTION

The invention provides a packaging process which avoids the problem that a subsequent surface treatment process lowers the reliability and electrical performance of a lower surface of a package mother board.

The invention provides a packaging process which includes the following processes. A package mother board is provided. The package mother board has an upper surface, a lower surface opposite to the upper surface, a device disposing area and a peripheral area surrounding the device disposing area. Plural semiconductor devices are disposed on the upper surface of the package mother board, and the semiconductor devices are located in the device disposing area. A carrier is provided. The carrier has a center area and an edge area surrounding the center area. An adhesive layer is formed between the peripheral area of the package mother board and the edge area of the carrier. The center area of the carrier is disposed corresponding to the device disposing area of the package mother board. The edge area of the carrier is disposed corresponding to the peripheral area of the package mother board. The adhesive layer is in a state of semi-curing, and the package mother board is bonded to the carrier via the adhesive layer. A baking process is performed so as to completely cure the adhesive layer.

In an embodiment of the invention, the process of forming the adhesive layer between the peripheral area of the package mother board and the edge area of the carrier includes forming the adhesive layer on the peripheral area of the package mother board; and providing the carrier on the lower surface of the package mother board, the package mother board being bonded to the edge area of the carrier via the adhesive layer.

In an embodiment of the invention, the process of forming the adhesive layer between the peripheral area of the package mother board and the edge area of the carrier includes forming the adhesive layer on the edge area of the carrier; and providing the package mother board on the carrier, the carrier being bonded to the peripheral area of the package mother board via the adhesive layer, and the adhesive layer being located between the carrier and the lower surface of the package mother board.

In an embodiment of the invention, the carrier includes a copper foil substrate or a glass fiber substrate.

In an embodiment of the invention, a method of forming the adhesive layer includes a screen printing process.

In an embodiment of the invention, a material of the adhesive layer includes solder mask, epoxy resin or adhesive materials.

In an embodiment of the invention, the baking process to completely cure the adhesive layer is performed at a temperature ranging from 150° C. to 180° C. for 30 minutes to 60 minutes.

In an embodiment of the invention, the package mother board includes a plurality of package daughter boards, and the semiconductor devices are disposed on the package daughter boards.

In an embodiment of the invention, the packaging process further including forming a surface treatment layer on a plurality of circuits of the package mother board after the baking process; and performing a cutting process to separate the carrier from the package mother board, and the package mother board is separated into package daughter boards independent from one another through the cutting process.

In an embodiment of the invention, the surface treatment layer includes a nickel-gold layer, a nickel-palladium-gold or an organic solderability preservative (OSP).

Based on the above, the packaging process of the invention first forms the adhesive layer in a state of semi-curing between the lower surface of the package mother board and the carrier and then performs a baking process to make the adhesive layer in a state of semi-curing turn to a state of complete curing, so that the package mother board is fixed on the carrier. Therefore, when the subsequent surface treatment process is performed, since the lower surface of the package mother board is covered by the carrier, solutions such as an electroplating solution cannot form an electroplated layer on the lower surface of the package mother board. Therefore, compared with conventional packaging processes, the packaging process of the invention has a better processing yield and allows the finished products of the subsequently formed package structures to have better structural reliability and electrical performance.

In order to make the aforementioned features and advantages of the invention more comprehensible, embodiments accompanying figures are described in details below.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the invention.

FIGS. 1A to 1D are schematic views illustrating a packaging process according to an embodiment of the invention.

FIGS. 2A to 2D are schematic views illustrating a packaging process according to an embodiment of the invention.

### DESCRIPTION OF EMBODIMENTS

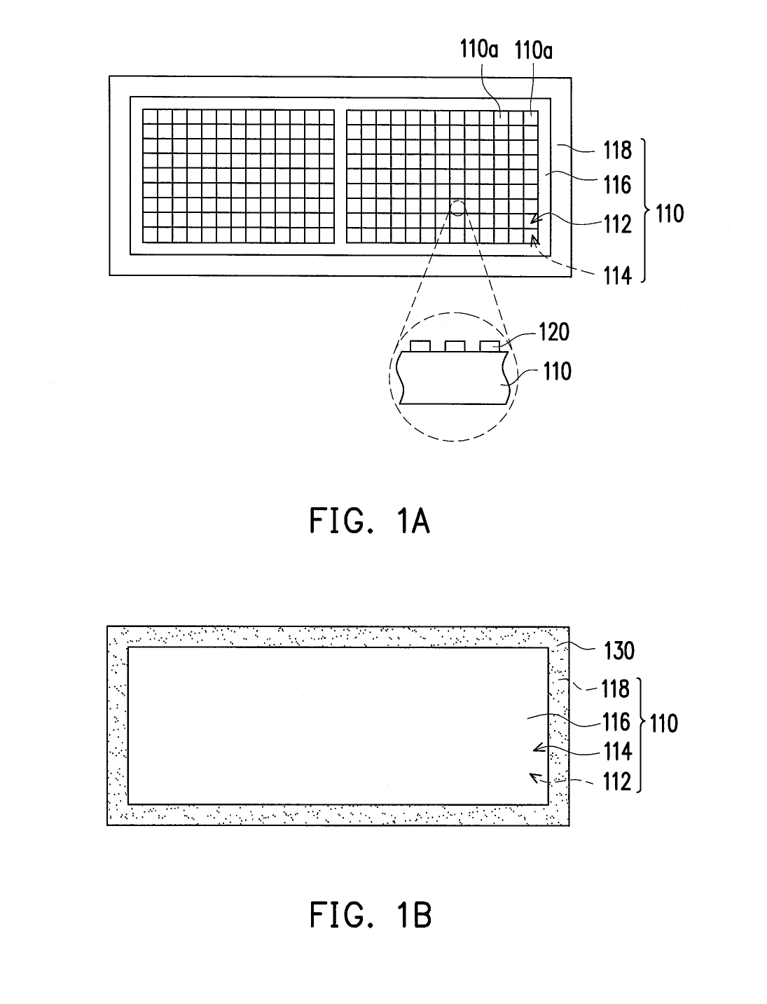

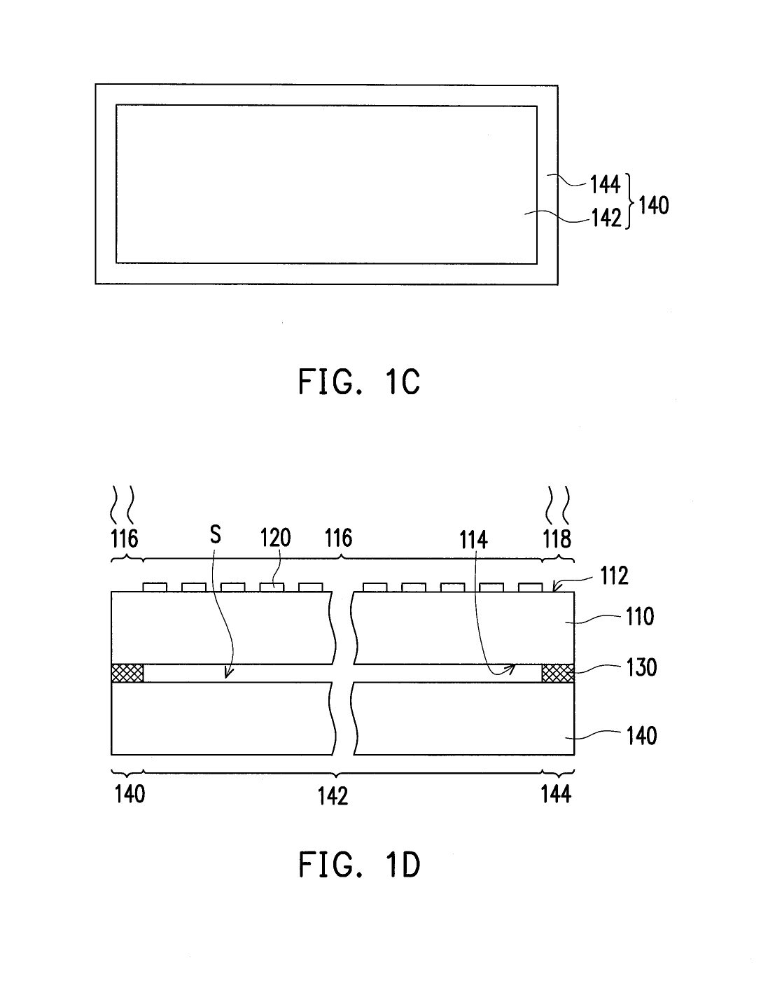

FIGS. 1A to 1D are schematic views illustrating a packaging process according to an embodiment of the invention. In order to facilitate illustration, FIGS. 1A to 1C are illustrated as schematic top views, and FIG. 1D is illustrated as a schematic cross-sectional view. According to the packaging process of the present embodiment, first, referring to FIG. 1A, a package mother board 110 is provided. Herein, the package mother board 110 has an upper surface 112, a lower surface 114 opposite to the upper surface 112, a device disposing area 116 and a peripheral area 118 surrounding the device disposing area 116. In the present embodiment, the package mother board 110 is composed of a plurality of package daughter boards 110a, and at least one semiconductor device 120 (multiple semiconductor devices are schematically illustrated in FIG. 1A) is disposed on each of the package daughter boards 110a. It should be noted that the semiconductor device 120 is, for example, a semiconductor chip, and the semiconductor device 120 is disposed on the upper surface 112 of the package mother board 110 and located in the device disposing area 116. Besides, the semiconductor device 120 may be electrically connected to the package daughter boards 110a through a wire-bonding process or a flip chip process, for example, which is not limited herein.

Then, referring to FIG. 1B, an adhesive layer 130 is formed on the peripheral area 118 of the package mother board 110, wherein a material of the adhesive layer 130 is, for example, solder mask, epoxy resin or adhesive materials such as AB glue. In particular, the adhesive layer 130 of the present embodiment is formed on the lower surface 114 of the package mother board 110, and the adhesive layer 130 is located only in the peripheral area 118; that is, the adhesive layer 130 does not exist in the device disposing area 116. At this time, the adhesive layer 130 is in a state of semi-curing. Herein, a method of forming the adhesive layer 130 is a screen printing process, for example.

Thereafter, referring to both FIGS. 1C and 1D, a carrier 140 is provided on the lower surface 114 of the package mother board 110, wherein the carrier 140 has a center area 142 and an edge area 144 surrounding the center area 142. In particular, in the present embodiment, the carrier 140 and the package mother board 110 have the same size, and the center area 142 of the carrier 140 is disposed corresponding to the device disposing area 116 of the package mother board 110, and the edge area 144 of the carrier 140 is disposed corresponding to the peripheral area 118 of the package mother board 110. The carrier 140 is, for example, a copper foil substrate or a glass fiber substrate. Herein, the package mother board 110 of the present embodiment is bonded to the carrier 140 via the adhesive layer 130 in a state of semi-curing, and the adhesive layer 130 is located between the peripheral area 118 of the package mother board 110 and the edge area 144 of the carrier 140. At this time, the lower surface 114 of the package mother board 110, the carrier 140 and the adhesive layer 130 form an enclosed space S.

Finally, referring to FIG. 1D again, a baking process is performed to completely cure the adhesive layer 130, so that the package mother board 110 is fixed on the carrier 140 stably. In other words, the completely cured adhesive layer 130 provides a better bonding force, so that the package mother board 110 is fixed on the carrier 140. Herein, the baking process to completely cure the adhesive layer 130 is performed at a temperature ranging from 150° C. to 180° C. for 30 minutes to 60 minutes. To this point, the packaging process of this stage is completed.

It should be noted that the structure composed of the package mother board 110, the semiconductor device 120, the adhesive layer 130 and the carrier 140 may be deemed a half-finished product of a package structure. Therefore, in subsequent steps of the manufacturing process, a surface treatment process may be performed to this half-finished product of the package structure to form a surface treatment layer on a plurality of circuits on the package mother board 110. The surface treatment layer includes a nickel-gold layer, a nickel-palladium-gold or an organic solderability preservative. Then, a cutting process is performed to separate the carrier 140 from the package mother board 110, and the package mother board 110 is separated into package daughter boards 110a independent from one another through the cutting process. The package daughter boards 110a at this time are finished products of package structures.

The packaging process of the present embodiment first forms the adhesive layer 130 in a state of semi-curing on the peripheral area 118 on the lower surface 114 of the package mother board 110, disposes the carrier 140 on the lower surface 114 of the package mother board 110, and then performs a baking process to make the adhesive layer 130 in a state of semi-curing turn to a state of complete curing, so that the package mother board 110 is fixed on the carrier 140. Therefore, when the subsequent surface treatment process is performed, since the lower surface 114 of the package mother board 110 is covered by the carrier 140, solutions such as an electroplating solution (not shown) are unable to enter the enclosed space S formed by the lower surface 114 of the package mother board 110, the carrier 140 and the adhesive layer 130 and thus do not form an electroplated layer on the lower surface 114 of the package mother board 110. Therefore, compared with conventional packaging processes, the packaging process of the present embodiment has a better processing yield and allows the finished products of the package structures formed subsequently to have better structural reliability and electrical performance.

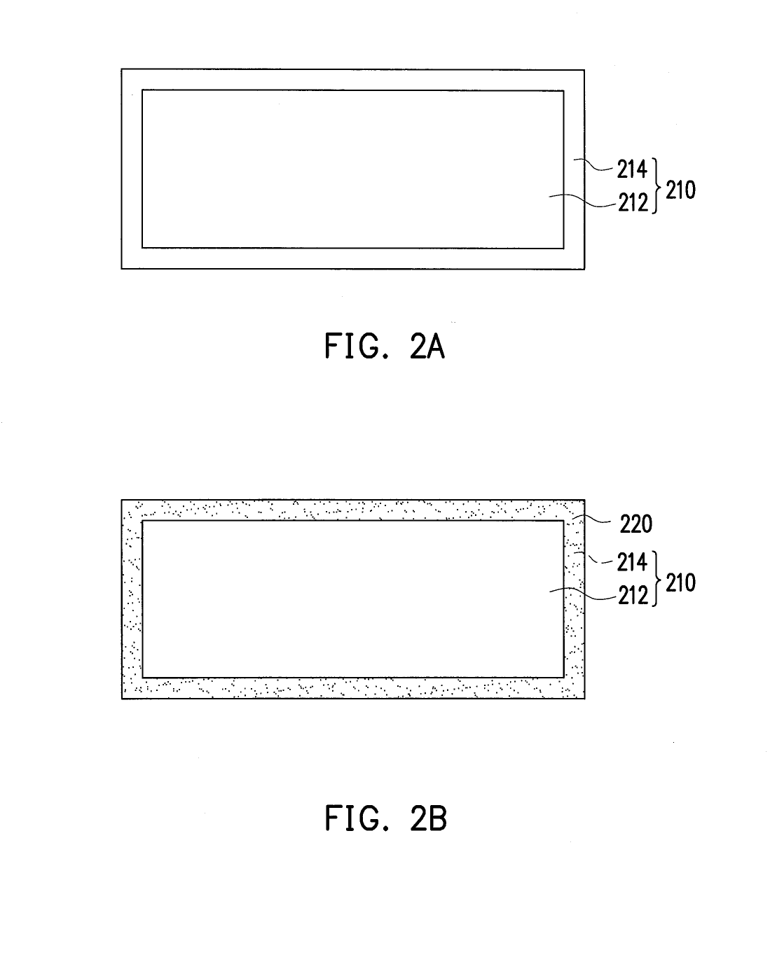

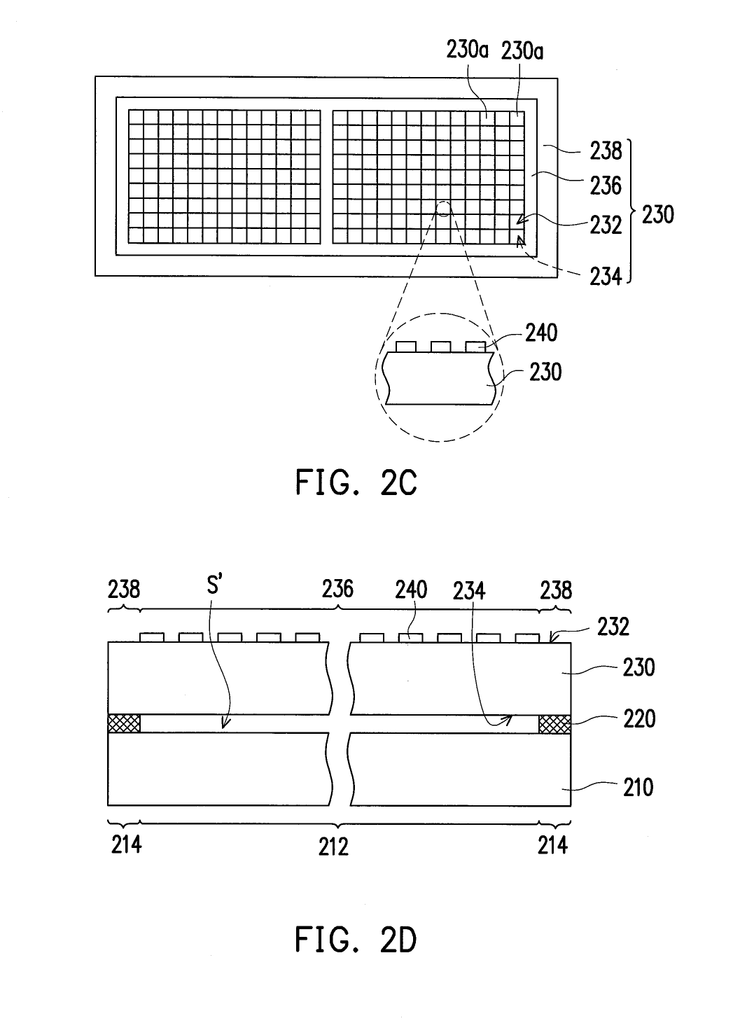

FIGS. 2A to 2D are schematic views illustrating a packaging process according to another embodiment of the invention. In order to facilitate illustration, FIGS. 2A to 2C are illustrated as schematic top views, and FIG. 2D is illustrated as a schematic cross-sectional view. According to the packaging process of the present embodiment, first, referring to FIG. 2A, a carrier 210 is provided, wherein the carrier 210 has a center area 212 and an edge area 214 surrounding the center area 212. Herein, the carrier 210 is, for example, a copper foil substrate or a glass fiber substrate.

Then, referring to FIG. 2B, an adhesive layer 220 is formed on the peripheral area 214 of the carrier 210, wherein a material of the adhesive layer 220 is, for example, solder mask, epoxy resin or adhesive materials such as AB glue. In particular, the adhesive layer 220 of the present embodiment is formed on the peripheral area 214 of the carrier 210, and the adhesive layer 220 does not exist in the center area 212 of the carrier 210. At this time, the adhesive layer 220 is in a state of semi-curing. Herein, a method of forming the adhesive layer 220 is a screen printing process, for example.

Thereafter, referring to both FIGS. 2C and 2D, a package mother board 230 is provided on the carrier 210, wherein the package mother board 230 has an upper surface 232, a lower surface 234 opposite to the upper surface 232, a device disposing area 236 and a peripheral area 238 surrounding the device disposing area 236. In the present embodiment, the package mother board 230 is composed of a plurality of package daughter boards 230a, and at least one semiconductor device 240 (multiple semiconductor devices are schematically illustrated in FIG. 2C) is disposed on each of the package daughter boards 230a. It should be noted that the semiconductor device 240 is, for example, a semiconductor chip, and the semiconductor device 240 is disposed on the upper surface 232 of the package mother board 230 and located in the device disposing area 236. Besides, the semiconductor device 240 may be electrically connected to the package daughter boards 230a through a wire-bonding process or a flip chip process, for example, which is not limited herein.

In particular, in the present embodiment, the package mother board 230 and carrier 210 have the same size, wherein the center area 212 of the carrier 210 is disposed corresponding to the device disposing area 236 of the package mother board 230, and the edge area 214 of the carrier 210 is disposed corresponding to the peripheral area 238 of the package mother board 230. Herein, the package mother board 230 of the present embodiment is bonded to the carrier 210 via the adhesive layer 220 in a state of semi-curing, and the adhesive layer 220 is located between the peripheral area 238 of the package mother board 230 and the edge area 214 of the carrier 210. At this time, the lower surface 234 of the package mother board 230, the carrier 210 and the adhesive layer 220 form an enclosed space S′.

Finally, referring to FIG. 2D again, a baking process is performed to completely cure the adhesive layer 230, so that the package mother board 230 is fixed on the carrier 210 stably. In other words, the completely cured adhesive layer 220 provides a better bonding force, so that the package mother board 230 is fixed on the carrier 210. Herein, the baking process to completely cure the adhesive layer 220 is performed at a temperature ranging from 150° C. to 180° C. for 30 minutes to 60 minutes. To this point, the packaging process of this stage is completed.

It should be noted that the structure composed of the carrier 210, the adhesive layer 220, the package mother board 230 and the semiconductor device 240 may be deemed a half-finished product of a package structure. Therefore, in subsequent steps of the manufacturing process, a surface treatment process may be performed to this half-finished product of the package structure to form a surface treatment layer on a plurality of circuits on the package mother board 230. The surface treatment layer includes a nickel-gold layer, a nickel-palladium-gold or an organic solderability preservative. Then, a cutting process is performed to separate the carrier 210 from the package mother board 230, and the package mother board 230 is separated into package daughter boards 230a independent from one another through the cutting process. The package daughter boards 230a at this time are finished products of package structures.

The packaging process of the present embodiment first forms the adhesive layer 220 in a state of semi-curing on the edge area 214 of the carrier 210, disposes the package mother board 230 on the carrier 210, and then performs a baking process to make the adhesive layer 220 in a state of semi-curing turn to a state of complete curing, so that the lower surface 234 of the package mother board 230 is fixed on the carrier 210. Therefore, when the subsequent surface treatment process is performed, since the lower surface 234 of the package mother board 230 is covered by the carrier 210, solutions such as an electroplating solution (not shown) are unable to enter the enclosed space S′ formed by the lower surface 234 of the package mother board 230, the carrier 210 and the adhesive layer 220 and thus do not form an electroplated layer on the lower surface 234 of the package mother board 230. Therefore, compared with conventional packaging processes, the packaging process of the present embodiment has a better processing yield and allows the finished products of the subsequently formed package structures to have better structural reliability and electrical performance.

In summary of the above, the packaging process of the invention first forms the adhesive layer in a state of semi-curing between the lower surface of the package mother board and the carrier and then performs a baking process to make the adhesive layer in a state of semi-curing turn to a state of complete curing, so that the package mother board is fixed on the carrier. Therefore, when the subsequent surface treatment process is performed, since the lower surface of the package mother board is covered by the carrier, solutions such as an electroplating solution cannot form an electroplated layer on the lower surface of the package mother board. Therefore, compared with conventional packaging processes, the packaging process of the invention has a better processing yield and allows the finished products of the subsequently formed package structures to have better structural reliability and electrical performance.

Although the invention has been described with reference to the above embodiments, they are not intended to limit the invention. It is apparent to people of ordinary skill in the art that modifications and variations to the invention may be made without departing from the spirit and scope of the invention. In view of the foregoing, the protection scope of the invention will be defined by the appended claims.

What is claimed is:

1. A packaging process, comprising:
providing a package mother board having an upper surface, a lower surface opposite to the upper surface, a device disposing area and a peripheral area surrounding the device disposing area, wherein a plurality of semiconductor devices are disposed on the upper surface of the package mother board, and the semiconductor devices are located in the device disposing area;
providing a carrier having a center area and an edge area surrounding the center area;
forming an adhesive layer between the peripheral area of the package mother board and the edge area of the carrier, wherein the center area of the carrier is disposed corresponding to the device disposing area of the package mother board, the edge area of the carrier is disposed corresponding to the peripheral area of the package mother board, the adhesive layer is in a state of semi-curing, and the package mother board is bonded to the carrier via the adhesive layer; and
performing a baking process to completely cure the adhesive layer.

2. The packaging process according to claim 1, wherein the step of forming the adhesive layer between the peripheral area of the package mother board and the edge area of the carrier comprises:
forming the adhesive layer on the peripheral area of the package mother board; and
providing the carrier on the lower surface of the package mother board, wherein the package mother board is bonded to the edge area of the carrier via the adhesive layer.

3. The packaging process according to claim 1, wherein the step of forming the adhesive layer between the peripheral area of the package mother board and the edge area of the carrier comprises:
forming the adhesive layer on the edge area of the carrier; and
providing the package mother board on the carrier, wherein the carrier is bonded to the peripheral area of the package mother board via the adhesive layer, and the adhesive layer is located between the carrier and the lower surface of the package mother board.

4. The packaging process according to claim 1, wherein the carrier comprises a copper foil substrate or a glass fiber substrate.

5. The packaging process according to claim 1, wherein a method of forming the adhesive layer comprises a screen printing process.

6. The packaging process according to claim 1, wherein a material of the adhesive layer comprises solder mask, epoxy resin or adhesive materials.

7. The packaging process according to claim 6, wherein the baking process to completely cure the adhesive layer is performed at a temperature ranging from 150° C. to 180° C. for 30 minutes to 60 minutes.

8. The packaging process according to claim 1, wherein the package mother board comprises a plurality of package daughter boards, and the semiconductor devices are disposed on the package daughter boards.

9. The packaging process according to claim 8, further comprising:
forming a surface treatment layer on a plurality of circuits of the package mother board after the baking process; and
performing a cutting process to separate the carrier from the package mother board, wherein the package mother board is separated into the package daughter boards independent from one another through the cutting process.

10. The packaging process according to claim 9, wherein the surface treatment layer comprises a nickel-gold layer, a nickel-palladium-gold or an organic solderability preservative (OSP).
